(19) United States
(12) Patent Application Publication
(10) Pub. No.: US 2006/0129798 A1
(43) Pub. Date: Jun. 15, 2006

(54) Stand-by power generator monitoring system

(75) Inventors: Gary Bance, Lake Elmo, MN (US); James Huebscher, Stillwater, MN (US)

Correspondence Address: KAGAN BINDER, PLLC, SUITE 200, MAPLE ISLAND BUILDING, 221 MAIN STREET NORTH, STILLWATER, MN, 55082, US

(73) Assignee: Allied Generators, Inc.

(21) Appl. No.: 11/289,071

(22) Filed: Nov. 29, 2005

Related U.S. Application Data
(60) Provisional application No. 60/631,658, filed on Nov. 30, 2004.

(51) Int. Cl. G06F 9/24

(52) U.S. Cl. 713/2

(57) ABSTRACT

A system for remotely monitoring operation of a stand-by power generator is provided. The system comprises a transfer switch for maintaining the powering of a load in the event of line voltage failure and a stand-by power generator. A sensor board is operably connected to the stand-by power generator to sense operation and/or failure of the stand-by power generator to operate, and also is operably connected to the load side of the transfer switch to sense provision and/or failure of provision of powering of a load. A logic board is operably connected to the sensor board to receive signals from the sensor board. The logic board comprises a signal apparatus capable of sending a signal to a remote location regarding information related to indicating i) provision and/or failure of provision of powering of a load, ii) operation and/or failure of the stand-by power generator to operate, and iii) time of operation of the stand-by power generator. A kit is also provided for configuring a system as described above.

This application claims the benefit of U.S. Provisional Application No. 60/631,658 filed on Nov. 30, 2004, the disclosure of which is hereby incorporated by reference.

### BACKGROUND OF THE INVENTION

Various systems have been designed to provide back-up electrical power in the case of loss of power from a primary source, such as an electric power utility company. Examples of alternative auxiliary power sources include battery power and stand-by power generators. Typical stand-by power generators are gasoline, diesel, propane or natural gas internal combustion engine-powered electrical generators. These generators can be provided with an automatic start mechanism that is activated in the event of loss of power from the primary source.

An example of a method and apparatus for providing standby power from a generator is described in U.S. Pat. No. 6,163,088 to Codina, et al. The method and apparatus described therein includes determining a power failure condition of a primary power source, disconnecting the primary power source from a load, connecting the generator to the load, connecting a first capacitor supplied voltage to a starter system, activating the starter system to start the generator, and providing a second capacitor supplied voltage to a capacitor monitor/diagnostics controller during a transition period between the primary power source and the generator standby power.

U.S. Pat. No. 6,172,432 to Schnackenberg, et. al. describes an automatic transfer switch apparatus for use with a stand-alone generator, for supplying emergency power to a residence or small business. The automatic transfer switch apparatus is configured to sense a utility line failure, start up and stabilize the generator, and switch over the household circuits from the utility to the generator, and switch back when the utility recovers. A load-shedding feature is provided for shedding and restoring different circuits within the residence that represent loads of different priority, with loads being shed and restored, according to their priority. An additional transfer switch and generator control means is disclosed in U.S. Pat. No. 3,363,368 to Sia.

### SUMMARY OF THE INVENTION

The present invention provides a system for remotely monitoring operation of a stand-by power generator. The system comprises a transfer switch for maintaining the powering of a load in the event of line voltage failure and a stand-by power generator. A sensor board is operably connected to the stand-by power generator to sense operation and/or failure of the stand-by power generator to operate, and also is operably connected to the load side of the transfer switch to sense provision and/or failure of provision of powering of a load. A logic board is operably connected to the sensor board to receive signals from the sensor board. The logic board comprises a signal apparatus capable of sending a signal to a remote location regarding information related to indicating
i) provision and/or failure of provision of powering of a load,
ii) operation and/or failure of the stand-by power generator to operate, and
iii) time of operation of the stand-by power generator.

As an additional aspect of the present invention, a kit is provided for configuring a system for remotely monitoring operation of a stand-by power generator. The kit comprises a sensor board capable of being operably connected to a stand-by power generator to sense operation and/or failure of the stand-by power generator to operate, and capable of being operably connected to the load side of a transfer switch to sense provision and/or failure of provision of powering of a load. The kit also comprises a logic board capable of being operably connected to the sensor board to receive signals from the sensor board; the logic board comprising a signal apparatus capable of sending a signal to a remote location regarding information related to indicating
i) provision and/or failure of provision of powering of a load,
ii) operation and/or failure of the stand-by power generator to operate, and
iii) time of operation of the stand-by power generator.

In an additional aspect of the present invention, a method of doing business is also provided, which comprises providing a system for remotely monitoring the operation of a stand-by power generator as described above, and establishing a remote location for receiving signals regarding information related to operation of the stand-by power generator from the system. Upon receipt of the information related to operation of the stand-by power generator from the system, the information is used to provide emergency and general maintenance services for the stand-by power generator.

The present invention provides a unique ability to remotely monitor stand-by power generators in a low cost manner. Additionally, the monitoring capabilities of the present system will provide not only emergency failure warning capabilities, but additionally present an opportunity to provide a dealer-focused maintenance system to provide remote care and monitoring of the functioning of the stand-by power generator, without the need to repeatedly dispatch maintenance personnel to the location of the stand-by power generator. Through the discovery of the possibilities of the present system, a new business method has been developed, wherein both emergency and general maintenance services can be provided on an economical and reliable basis for the stand-by power generator.

### BRIEF DESCRIPTION OF THE DRAWINGS

FIG. 1 is a photograph and diagram of an exemplary system of the present invention.

FIG. 2 is a specification sheet of an exemplary system of the present invention.

FIG. 3 is a schematic diagram of an exemplary 200 V sensor used in a system of the present invention.

FIG. 4 is a schematic diagram of an exemplary 400 V sensor used in a system of the present invention.

FIG. 5 is a schematic diagram of an exemplary logic board used in a system of the present invention.

FIG. 6 is a schematic diagram of an exemplary logic board used in a system of the present invention.

FIG. 7 is a schematic diagram and installation sheet for installing an exemplary system, also called a Monitoring Panel, of the present invention.

FIG. 8 is a LED description of an exemplary logic board of the present invention.

FIG. 9 is an image of a screen that serves as an interface between the technician and the software program at the remote location.

FIG. 10 is an image of a screen that serves as an interface between the technician and the software program at the remote location.

FIG. 11 is an image of a screen that serves as an interface between the technician and the software program at the remote location.

### DETAILED DESCRIPTION

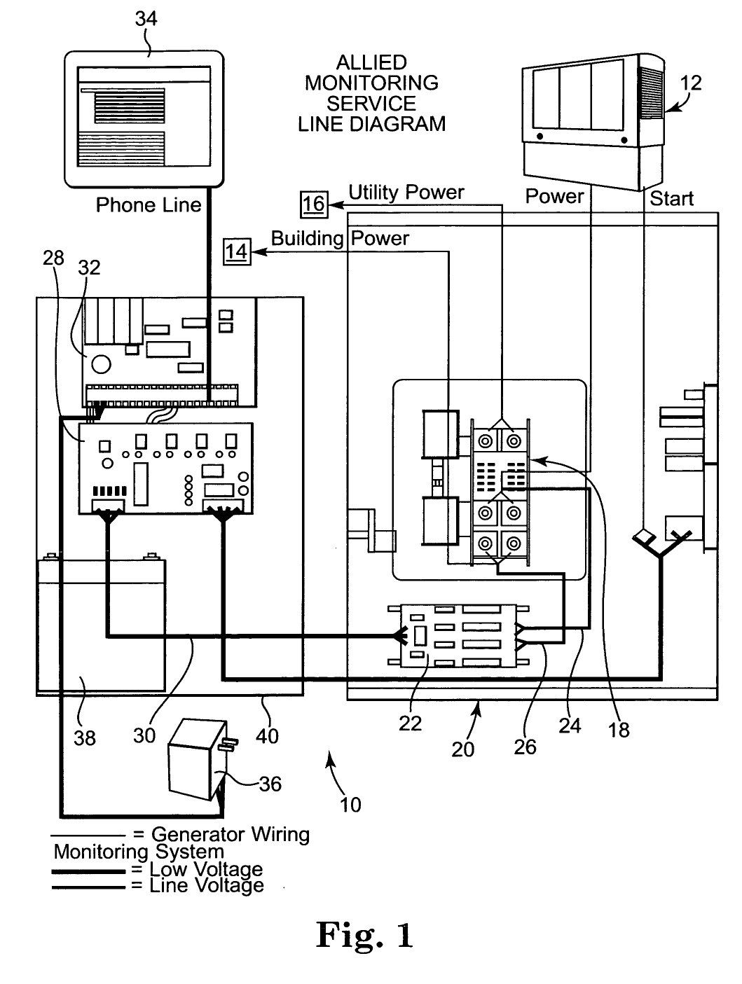

Turning now to FIG. 1, system 10 is provided for remotely monitoring operation of a stand-by power generator 12 and providing power to load 14 in the event of failure of utility 16 to provide power. Transfer switch 18 to be used in the system of the present invention is a switch for maintaining the powering of load 14 by transfer of the load from the line voltage supplied by utility 16 to the stand-by power generator 12 in the event of failure of the line voltage. Automated transfer switches are conventionally provided with commercially available generators, and may be of any type appropriate for use with the particular generator and the requirements of the load. Examples of various transfer switch configurations are described in the patents discussed above. The transfer switch is preferably provided in a separate transfer switch box 20, preferably rated to be appropriate for containing line voltage connections.

The stand-by power generator 12 to be used in the system of the present invention may be of any type appropriate for use in view of the power requirements of the particular anticipated load. Such generators are readily commercially available. Examples of stand-by power generators are described in the patents discussed above.

Sensor board 22 is operably connected to the stand-by power generator 12 in order to sense operation and/or failure of the stand-by power generator 12 to operate by line voltage line 24. Sensor board 22 is also operably connected to the load side of the transfer switch 18 by line voltage line 26 to sense provision and/or failure of provision of powering of load 14. The sensing of the operation of the stand-by power generator and of powering of load can be carried out by direct measurement or by induction sensing, both of which are considered to be “operably connected” for purposes of the present invention. Sensor board 22 is preferably provided in transfer switch box 20.

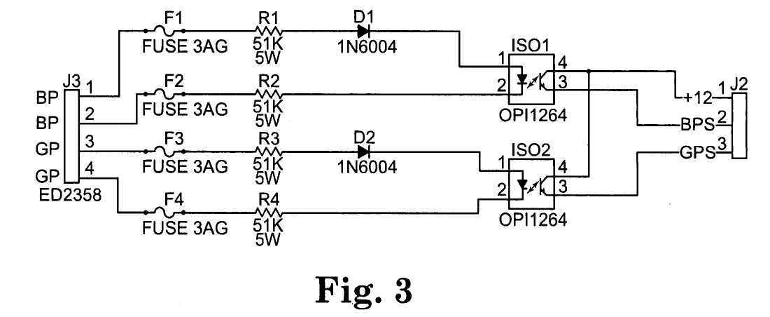

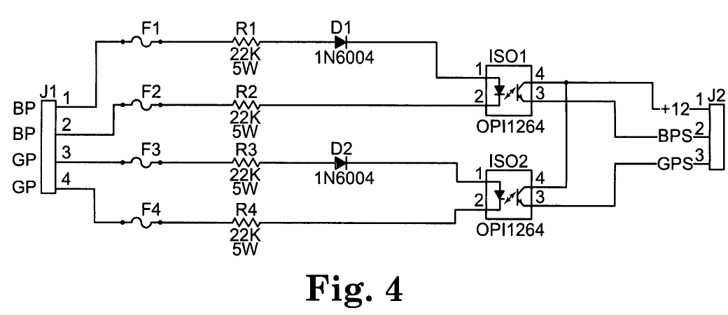

Optionally, sensor board 22 can be provided with a number of additional sensors to monitoring various functions or physical property measurements desirable for maintenance of the stand-by power generator 12. Schematic diagrams of exemplary 200 V and 400 V sensors that can be used in a system of the present invention are provided as FIGS. 3 and 4.

Logic board 28 is operably connected to sensor board 22 by low voltage line 30 to receive signals from sensor board 22. Logic board 28 is comprises a signal apparatus 32 that is capable of sending a signal to a remote location 34 regarding information related to indicating:
i) provision and/or failure of provision of powering of a load,
ii) operation and/or failure of the stand-by power generator to operate, and
iii) time of operation of the stand-by power generator.

In one embodiment, signal apparatus 34 is a dialer connected to a land-line telephone system, or alternatively to a cellular telephone system. In another embodiment, signal apparatus 32 is a messaging system connected to the internet. The signal to be sent to remote location 34 can be provided in any appropriate format, such as in the form of an email message or as a text message to a telephone.

Logic board 28 and signal apparatus 34 is preferably provided with AC power by AC power connector 36, and additionally comprises a battery power source 38 to provide power for carrying out functions in the event of failure of the AC power source.

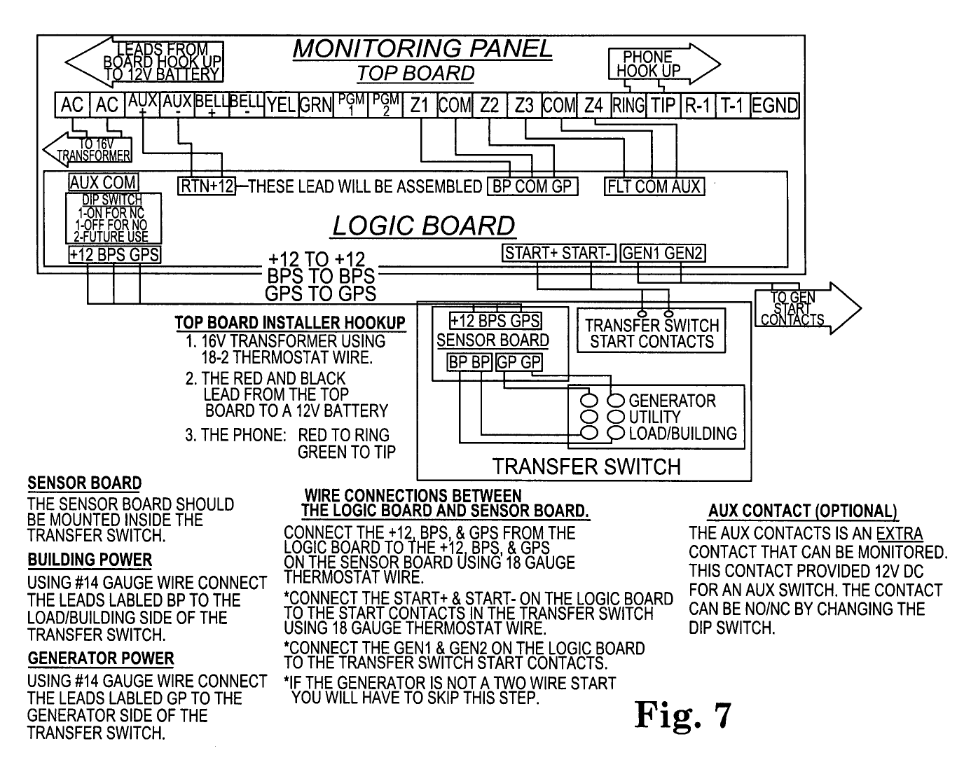

Logic board 28 is preferably provided in a separate cabinet 40 that is preferably rated to be appropriate for containing low voltage connections. Isolation of components into a separate cabinet 40 that is a low voltage cabinet is particularly advantageous, because installation and maintenance is significantly simplified by the configuration as shown. Thus, installation of components as described herein can readily be carried out by generator technicians, without the need to utilize installers that are qualified by training (and license, where applicable) as electricians. FIG. 7 is a schematic diagram and installation sheet for installing an exemplary system, also called a Monitoring Panel, of the present invention.

Optionally, logic board 28 can be provided with a number of sensors (which are preferably low voltage sensors) to monitoring various functions or physical property measurements desirable for maintenance of the stand-by power generator 12. For example, logic board 28 can comprise a sensor for measuring fuel level of the stand-by power generator and/or a sensor for determining the transfer switch position.

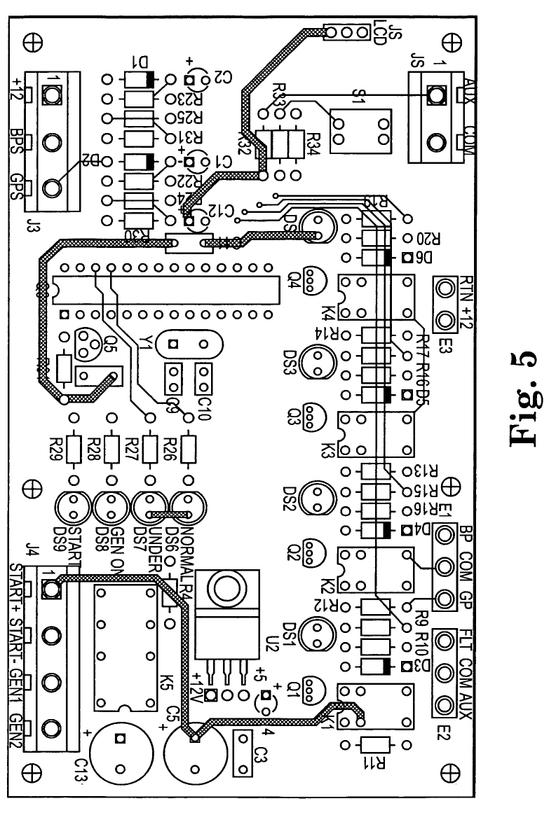

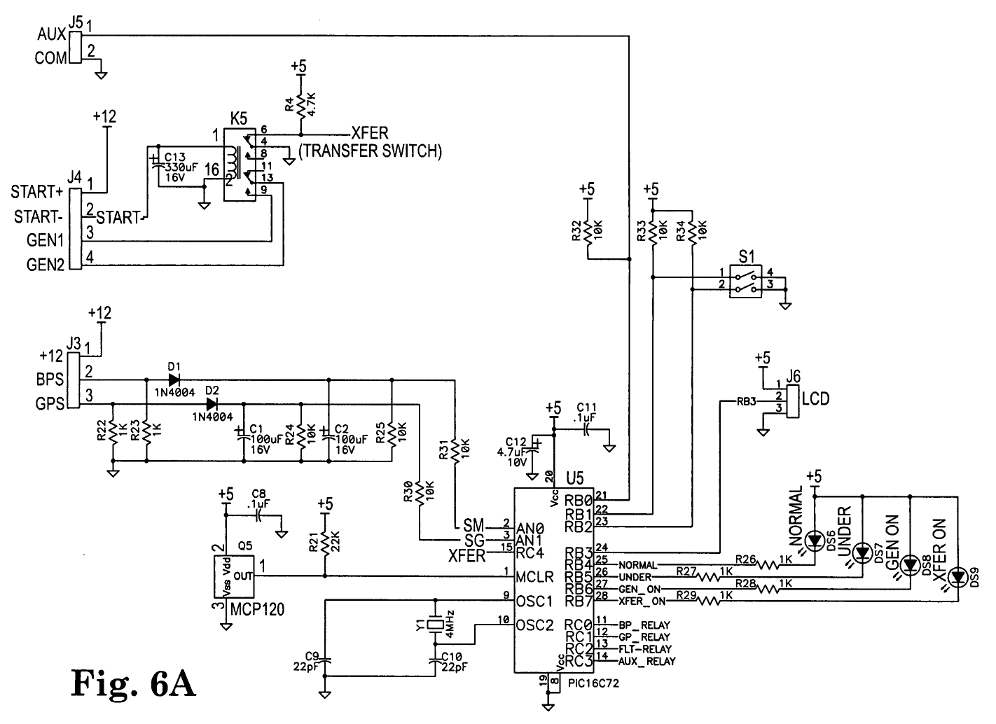

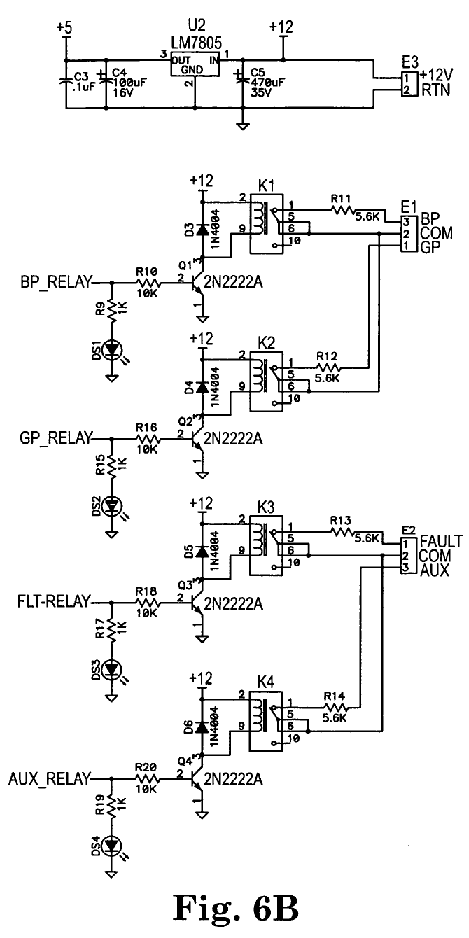

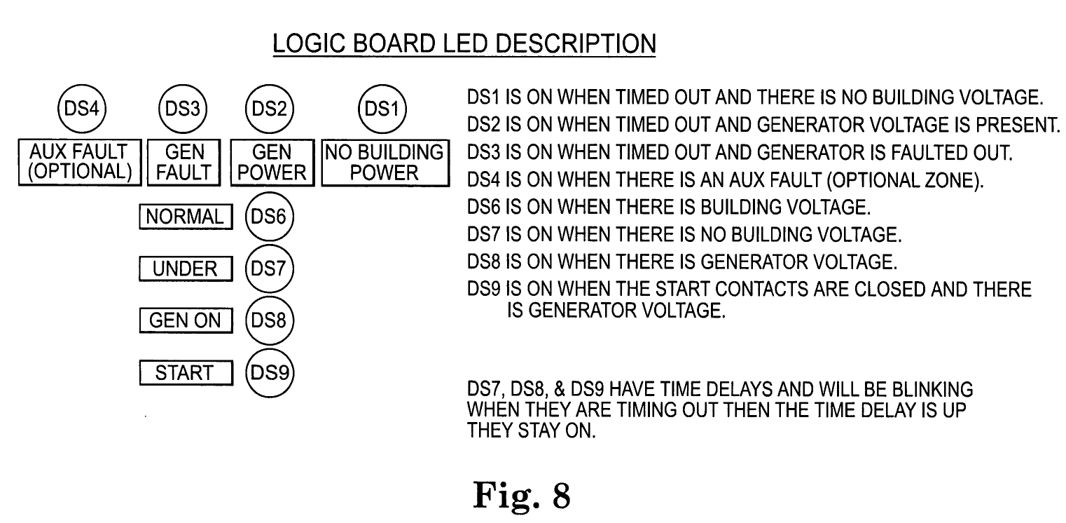

FIGS. 5 and 6 show schematic diagrams of exemplary logic boards that can be used in a system of the present invention. FIG. 8 is a LED description of an exemplary logic board of the present invention.

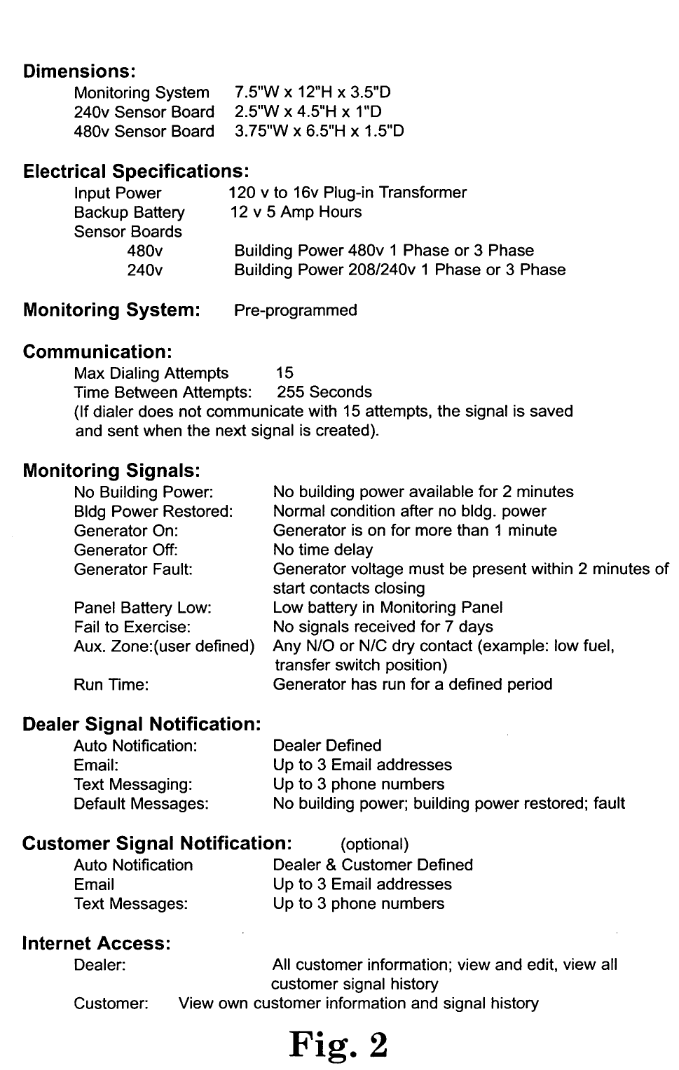

Specifications for preferred systems of the present invention are set forth in FIG. 2.

The system of the present invention may send a number of signals to the remote location in order to provide desired information for both emergency and maintenance support of the stand-by power generator. In a preferred embodiment, the system sends a signal to the remote location in the event of failure of provision of powering of a load for a predetermined time period. The predetermined time period may be any appropriate period, based on user requirements and urgency of continuous supply of power to the load. In a preferred embodiment, the predetermined time period is a period of about two minutes. In another embodiment, a signal is sent to the remote location in the event of restoration of power after failure of provision of powering of a load. In another embodiment, a signal is sent to the remote location on a predetermined periodic basis to confirm operation of the system.

The signals are sent to a remote location, which preferably is a dealership and/or maintenance location having generator service and repair capability as part of its regular business operation. Alternatively, the remote location can be a communication center such as a security or message center location, which evaluates the information received from the system and notifies service personnel of need for action in a timely manner as appropriate for the condition of the stand-by power generator and function of the system.

Preferably, the remote location comprises software to accept signals from the logic board and to present the information in a format usable to indicate stand-by power generator emergency and regular maintenance status. Preferably, the software comprises an algorithm for determining maintenance needs of the stand-by power generator based on signals received from the logic board. In another embodiment, preferably the software comprises an algorithm for determining whether initiation of operation of the stand-by generation was in response to failure of provision of powering of a load. In another embodiment, preferably the software comprises an algorithm for determining whether initiation of operation of the stand-by generation was in response to operation of an automatic self-test of the stand-by generator. In another embodiment, preferably the software comprises an algorithm for determining the total run time of the stand-by generator during a predetermined time period.

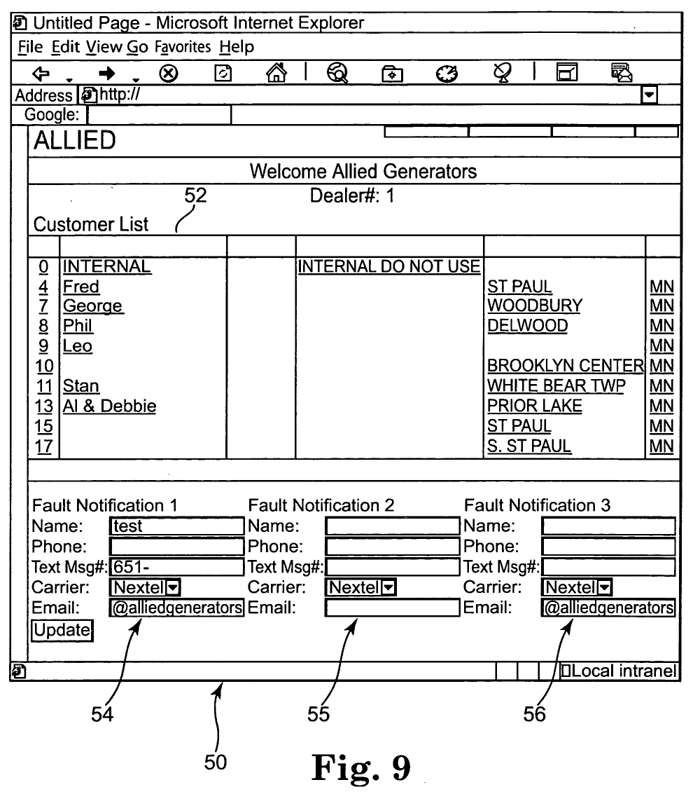

FIG. 9 is an image of screen 50 that serves as an interface between the technician and the software program at the remote location. Customer Field 52 provides information regarding identification of various customers being monitored by the system. Detailed information regarding specific system activity may optionally be accessed by clicking on a link to the specific customer, or by using the customer information displayed on this screen to access system activity of the specific customer through a different screen. Fault Notification Fields 54, 55 and 56 provide prioritized notification information to contact personnel associated with the remote location and or personnel associated with the customer. The mode of contact (e.g. by telephone, text messaging or email) can be designated in Fault Notification Fields 54, 55 and 56. The order of notification can also be designated in Fault Notification Fields 54, 55 and 56. In a preferred embodiment, all designated fault notification contact persons are contacted simultaneously or nearly simultaneously to provide a redundant fault notification system.

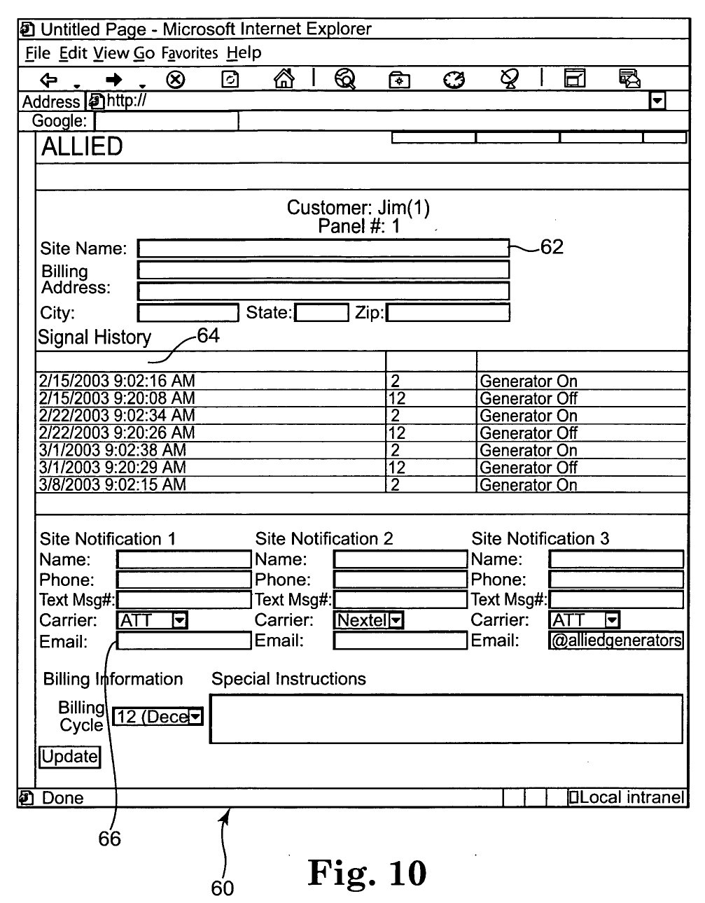

FIG. 10 is an image of screen 60 that serves as an interface between the technician and the software program at the remote location. Customer information field 62 can be populated to provide specific customer information. Signal history field 64 is populated with historical data regarding generator activity. From this data, frequency and duration of operation of the generator can be calculated, and further can provide information for calculating maintenance needs of the generator. Site notification fields 66 can be populated with contact information either of a person associated with the remote location and/or customer contact information.

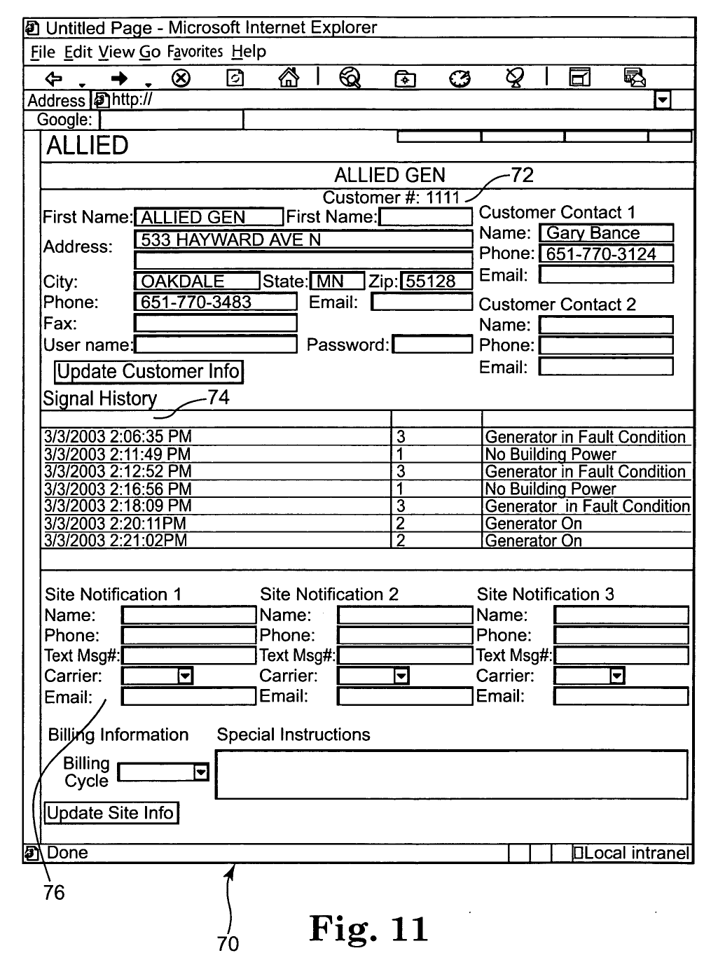

FIG. 11 is an image of screen 70 that serves as an interface between the technician and the software program at the remote location. Customer information field 72 can be populated to provide specific customer information. Signal history field 74 is populated with historical data regarding line voltage power supply and generator activity. From this data, frequency and duration of power outages and operation of the generator can be reported. Data as provided here can provide information for calculating emergency and maintenance needs of the generator. Site notification fields 76 can be populated with contact information either of a person associated with the remote location and/or customer contact information.

In another aspect of the present invention, a kit is provided for configuring a system for remotely monitoring operation of a stand-by power generator, comprising:

a) a sensor board capable of being operably connected to a stand-by power generator to sense operation and/or failure of the stand-by power generator to operate, and capable of being operably connected to the load side of a transfer switch to sense provision and/or failure of provision of powering of a load;

b) a logic board capable of being operably connected to the sensor board to receive signals from the sensor board; the logic board comprising a signal apparatus capable of sending a signal to a remote location regarding information related to indicating
i) provision and/or failure of provision of powering of a load,
ii) operation and/or failure of the stand-by power generator to operate, and
iii) time of operation of the stand-by power generator.

The kit as described herein provides substantial benefit in ease of installation, and also establishing a remote monitoring system that will provide information for both emergency and regular maintenance in an economical fashion.

As discussed above, the method of doing business provides a unique capability for remote monitoring, whereby suppliers, and particularly generator dealers, are able to provide an economical and reliable maintenance service to customers. The method as described herein further contemplates the generation of periodic (e.g. monthly) fees for providing cost-effective maintenance of stand-by power generation equipment.

All percentages and ratios used herein are weight percentages and ratios unless otherwise indicated. All publications, patents and patent documents cited are fully incorporated by reference herein, as though individually incorporated by reference. Numerous characteristics and advantages of the invention meant to be described by this document have been set forth in the foregoing description. It is to be understood, however, that while particular forms or embodiments of the invention have been illustrated, various modifications, including modifications to shape, and arrangement of parts, and the like, can be made without departing from the spirit and scope of the invention.

1. A system for remotely monitoring operation of a stand-by power generator, comprising:
a) a transfer switch for maintaining the powering of a load in the event of line voltage failure;
b) a stand-by power generator;
c) a sensor board operably connected to the stand-by power generator to sense operation and/or failure of the stand-by power generator to operate, and operably connected to the load side of the transfer switch to sense provision and/or failure of provision of powering of a load;
d) a logic board operably connected to the sensor board to receive signals from the sensor board; the logic board comprising a signal apparatus capable of sending a signal to a remote location regarding information related to indicating
i) provision and/or failure of provision of powering of a load,
ii) operation and/or failure of the stand-by power generator to operate, and
iii) time of operation of the stand-by power generator.

2. The system of claim 1, wherein the remote location comprises software to accept signals from the logic board and to present said information in a format usable to indicate stand-by power generator emergency and regular maintenance status.

3. The system of claim 2, wherein the software comprises an algorithm for determining maintenance needs of the stand-by power generator based on signals received from the logic board.

4. The system of claim 2, wherein the software comprises an algorithm for determining whether initiation of operation of the stand-by generation was in response to failure of provision of powering of a load.

5. The system of claim 2, wherein the software comprises an algorithm for determining whether initiation of operation of the stand-by generation was in response to operation of an automatic self-test of the stand-by generator.

6. The system of claim 2, wherein the software comprises an algorithm for determining the total run time of the stand-by generator during a predetermined time period.

7. The system of claim 1, wherein the logic board additionally comprises a sensor for measuring fuel level of the stand-by power generator.

8. The system of claim 1, wherein the logic board additionally comprises a sensor for determining the transfer switch position.

9. The system of claim 1, wherein the signal apparatus is a dialer connected to a land-line telephone system or a cellular telephone system.

10. The system of claim 1, wherein the signal apparatus is a messaging system connected to the internet.

11. The system of claim 1, wherein the signal sent to a remote location is in the form of an email message.

12. The system of claim 1, wherein the signal sent to a remote location is in the form of a text message to a telephone.

13. The system of claim 1, wherein a signal is sent to the remote location in the event of failure of provision of powering of a load for a predetermined time period.

14. The system of claim 13, wherein the predetermined time period is a period of about two minutes.

15. The system of claim 1, wherein a signal is sent to the remote location in the event of restoration of power after failure of provision of powering of a load.

16. The system of claim 1, wherein a signal is sent to the remote location on a predetermined periodic basis to confirm operation of the system.

17. The system of claim 1, wherein the sensor board is located in a panel that additionally contains the transfer switch, and wherein the logic board is provided in a separate low voltage panel that is external to the panel containing the transfer switch.

18. A kit for configuring a system for remotely monitoring operation of a stand-by power generator, comprising:
a) a sensor board capable of being operably connected to a stand-by power generator to sense operation and/or failure of the stand-by power generator to operate, and capable of being operably connected to the load side of a transfer switch to sense provision and/or failure of provision of powering of a load;
b) a logic board capable of being operably connected to the sensor board to receive signals from the sensor board; the logic board comprising a signal apparatus capable of sending a signal to a remote location regarding information related to indicating
i) provision and/or failure of provision of powering of a load,
ii) operation and/or failure of the stand-by power generator to operate, and
iii) time of operation of the stand-by power generator.

19. A method of doing business comprising:
a) providing a system for remotely monitoring the operation of a stand-by power generator of claim 1,
b) establishing a remote location for receiving signals regarding information related to operation of the stand-by power generator from the system,
c) upon receipt of information related to operation of the stand-by power generator from the system, using the information to provide emergency and general maintenance services for the stand-by power generator.
